(19) United States
(12) Patent Application Publication
(10) Pub. No.: US 2025/0327498 A1
(43) Pub. Date: Oct. 23, 2025

(54) BRAKE PAD SET AND VEHICLE BRAKE

(71) Applicant: ZF Active Safety GmbH, Koblenz (DE)

(72) Inventor: Florian Roessinger, Neuwied (DE)

(73) Assignee: ZF Active Safety GmbH, Koblenz (DE)

(21) Appl. No.: 19/184,430

(22) Filed: Apr. 21, 2025

(30) Foreign Application Priority Data
Apr. 23, 2024 (DE) 102024203785.0

(51) Int. Cl. F16D 65/095; F16D 55/226

(52) U.S. Cl. CPC F16D 65/095; F16D 55/226

(57) ABSTRACT

A brake pad set for disc brakes is disclosed, comprising an inner brake pad and an outer brake pad. In this case, each of the brake pads has a backplate and a brake lining, which is mounted on the backplate and comes into contact with a brake rotor during operation. The inner brake lining and the outer brake lining differ in size and may also different in geometrical shape in plan view, wherein the volume of wear of the inner brake pad and the volume of wear of the outer brake pad differ by less than 10%. In addition, a vehicle brake having such a brake pad set is disclosed.

### CROSS-REFERENCE TO RELATED APPLICATIONS

This application claims priority to German Patent Application No. 102024203785.0, filed Apr. 23, 2024, the disclosure of which is incorporated herein by reference in its entirety.

### TECHNICAL FIELD

The disclosure relates to a brake pad set for disc brakes, comprising an inner brake pad and an outer brake pad, wherein each brake pad has a backplate and a brake lining, which is mounted on the backplate and comes into contact with a brake rotor during operation. In addition, the disclosure relates to a vehicle brake comprising a brake calliper, a brake carrier, into which a brake rotor projects, an actuator unit and such a brake pad set.

### BACKGROUND

Normally, brake linings of an inner and an outer brake pad do not differ substantially from one another, and therefore the brake linings are of approximately the same size. In this case, the outer brake pad is held axially by two abutment extensions on the brake calliper and is accordingly supported by the two abutment extensions during a braking operation. In contrast, the inner brake pad is acted upon by a brake piston, which usually engages in the centre of the brake pad.

As a result, a central region of the inner brake pad, for example, the brake lining of the inner brake pad, is subjected to significantly greater pressure than the outer regions of the inner brake lining, which are not acted upon directly by the brake cylinder. In other words, there is therefore partially greater wear in the region of the brake piston. Accordingly, a severely worn brake lining projects towards the brake rotor in the regions adjacent to the contact surface with the brake piston, and therefore the outer brake lining regions of the inner brake pad may remain in contact with the brake rotor when the vehicle brake is released. There is therefore what is referred to as a residual braking torque. In addition, the rubbing of the outer brake lining regions on the brake rotor may result in troublesome noises for the occupants.

Moreover, there is the fact that the uneven wear of the brake linings and the unequal force distribution due to the action of a single cylinder makes it impossible to ensure fully uniform braking power over the entire surface. This is a problem especially in the case of electromechanical brakes since electromechanical brakes have large brake pads with large brake linings and a relatively small brake piston.

In order to obtain more uniform force distribution during the braking operation, use is often made of force distributors, which are intended to distribute the force exerted by the brake piston uniformly to the brake pad. However, these components are heavy and require additional installation space.

Accordingly, what is needed is to provide a brake pad set which allows improved force distribution and thus uniform wear of the brake linings. In addition, a vehicle brake which uses such a brake pad set is also needed.

### SUMMARY

According to the disclosure, a brake pad set for disc brakes proposed, comprising an inner brake pad and an outer brake pad. In this case, each of the brake pads has a backplate and a brake lining, which is mounted on the backplate and comes into contact with a brake rotor during operation. The inner brake lining and the outer brake lining differ in size and may also in geometrical shape in plan view, wherein the volume of wear of the inner brake pad and the volume of wear of the outer brake pad differ by less than 10%. In other words, the inner brake lining and the outer brake lining differ in size and have different geometrical shapes in plan view, while the volume of wear remains almost the same. Here, the differences in size and in geometrical shape in a plan view of the brake linings (i.e. viewed towards the friction surface) are outside the production tolerances.

In addition, a vehicle brake, for example an electromechanical vehicle brake, comprising a brake calliper, a brake carrier, into which a brake rotor projects, an actuator unit and the brake pad set described above is also disclosed.

The difference in size and shape of the inner and outer brake linings results in an optimized force distribution during the braking operation, and therefore the entire brake lining of the brake pads is acted upon in each case. Thus, regions with partially higher wear are prevented. Accordingly, there is no longer a need for a force distributor to distribute the force exerted by the brake piston uniformly to the brake lining, thus making it possible to save installation space, weight and costs. The virtually equal volume of wear furthermore ensures that there is virtually no difference in the wear of the inner and outer brake linings, and thus resources are saved.

Since, according to the disclosure, the size and shape of the brake linings are changed only in plan view, the backplates remain unchanged as compared with previous backplates. This has the advantage that it is possible to change over to the brake pad sets according to the disclosure at any time and that any disc brake may also be retrofitted with the brake pad sets according to the disclosure.

Accordingly, in one exemplary arrangement, only the brake linings that are modified in the brake pad set according to the disclosure, that is to say only the size and shape, in plan view, of the brake linings are changed, the backplates thus remaining unchanged and continuing to be usable in the already installed vehicle brakes. Thus, the optimized brake pad set can be used without problems even in already installed vehicle brakes without resulting in higher costs for a vehicle owner or a vehicle buyer since only the brake pad set and not the entire vehicle brake have to be exchanged.

According to one exemplary arrangement, the brake lining of the inner brake pad is of square or circular design in plan view. In addition or as an alternative, the brake lining of the outer brake pad can have an arc shape or a rectangular shape in plan view. The idea behind this is to adapt the shape of the brake lining in plan view to the shape of the force application device. The important point here is that the best possible shape corresponds to the shape of the brake cylinder and the shape of the abutment extensions for the inner brake lining and the outer brake lining. The brake cylinder is usually round, and accordingly the best possible shape of the inner brake lining is therefore circular. However, a square inner brake lining is also more similar to the shape of the brake cylinder than an elongated rectangle, which is not subjected to force directly by the brake cylinder on the outer sides of the brake lining. Since the outer brake lining is acted upon by two abutment extensions, it is may be rectangular or arc-shaped, ensuring that both abutment extensions have sufficient space to exert force on the brake pad or brake lining.

The brake lining of the outer brake pad may have a larger area in plan view than the brake lining of the inner brake pad. For example, the outer brake pad has a brake lining with an area larger by at least 10%, and in one exemplary arrangement, an area larger by between 20 and 300%. By virtue of the fact that the inner brake lining is subjected to the braking force at only a single location, it can be made smaller in comparison with the outer brake lining, which is supported by the abutment extensions at two locations. In order to ensure uniform force distribution, the outer brake lining must accordingly be larger than the inner brake lining.

Since the volume of wear of the inner brake lining and of the outer brake lining should differ by less than 10%, the brake lining of the inner brake pad can be thicker than the brake lining of the outer brake pad. If the area of the inner brake lining is reduced, its thickness must be made greater in order to keep the volume of wear as constant as possible. Owing to the approximately equally large volume of wear, the inner and the outer brake lining are thus uniformly worn, and therefore the two brake linings must be replaced approximately at the same time. Accordingly, it is possible by an approximately constant volume of wear to prevent wastage of material since the inner and the outer brake lining exhibit similar wear. Since, in order to achieve a mechanical connection between the backplate and the friction lining, the brake lining may under certain circumstances project into a recess in the backplate or the backplate may have small extensions around which there is friction material, reliance is not placed solely on the friction lining volume but on the predetermined volume of wear thereof, which, for example, extends as far as a first point of contact of the backplate with the brake rotor and starts from a new brake lining.

According to the disclosure, the thickness of the friction lining is understood to mean the dimension of the brake lining starting from the backplate in the axial direction.

According to another exemplary arrangement, the backplate of the inner brake pad is thicker than the backplate of the outer brake pad. Alternatively, the thickness of the backplates of the inner brake pad and of the outer brake pad is the same. A thicker backplate enables the brake lining of the inner brake pad to be pressed more strongly against the brake rotor, thus making it possible to produce a constant or higher braking effect despite the smaller area or size of the brake lining.

According to one exemplary arrangement, the brake lining of the outer brake pad is divided into two. In other words, the brake lining of the outer brake pad has a gap in the region of the interspace between the two abutment extensions. In this way, it is possible to avoid partially higher wear in the centre of the outer brake disc since this region can no longer be acted upon by both abutment extensions.

The brake lining of the outer brake pad and the brake lining of the inner brake pad can be manufactured from different materials. In this case, the materials for the brake lining of the various brake pads are selected according to the different requirements. Accordingly, the inner and the outer brake lining may differ in the friction coefficient and hardness of the material. In this case, the outer brake lining usually has a higher friction coefficient than the inner brake lining, thus making it possible also to avoid heat stress cracks in the brake lining, for example.

As an alternative to a square or circular shape in the plan view of the inner brake lining, a rectangular shape or arc shape approximating to the shape of a square may also be employed. In this case, the rectangular shape of the inner brake lining has a ratio of width to height of less than or equal to 3:2, for example less than or equal to 4:3, and in one exemplary arrangement, less than or equal to 5:4.

If the inner brake lining has an arc shape, the width at the radial height of the brake lining at which the central axis of the brake cylinder is located is taken as the width.

As an option, the ratio of the height (radial dimension) to the width of the brake lining of the inner brake pad is between 0.6 and 1.1. From the ratio, it is evident that a somewhat square shape is designed for the inner brake lining. The important point is that this form factor is applicable exclusively to the inner brake lining.

According to one exemplary arrangement, the brake lining of the inner brake pad and the brake lining of the outer brake pad are arranged at different radial heights in relation to the brake rotor. With this arrangement, it is possible to ensure that the centre of force application to the inner brake pad and the outer brake pad is at the same radial height of the brake rotor. In this way, an optimum braking power or an optimized braking characteristic can be ensured.

As already mentioned above, a vehicle brake is also disclosed.

The actuator unit of this vehicle brake engages centrally on the inner brake pad. In addition, the brake calliper can have abutment extensions, on which the backplate of the outer brake pad is supported by rear-side contact surfaces when the brake is activated. In contrast, the inner brake pad can have a rear-side contact surface with the actuator unit, for example the brake cylinder, which surface, when viewed in the axial direction, is situated between the contact surfaces of the outer backplate with the abutment extensions.

### BRIEF DESCRIPTION OF THE DRAWINGS

Further features and advantages will be found in the following description, which makes reference to the following drawings. In the drawings:

FIG. 1 shows a perspective view of a vehicle brake according to the disclosure;

FIG. 2 shows a perspective view of the outside of the vehicle brake shown in FIG. 1 without a brake calliper and without an actuator unit, making it possible to see the brake pad set according to the disclosure;

FIG. 3 shows a perspective view of the inside of the vehicle brake shown in FIG. 1 without a brake calliper and without an actuator unit;

FIG. 4 shows a plan view of the vehicle brake shown in FIG. 1 without the brake calliper and actuator unit;

FIG. 5 shows a schematic illustration of the inner brake pad; and

FIG. 6 shows a schematic illustration of the outer brake pad.

### DETAILED DESCRIPTION

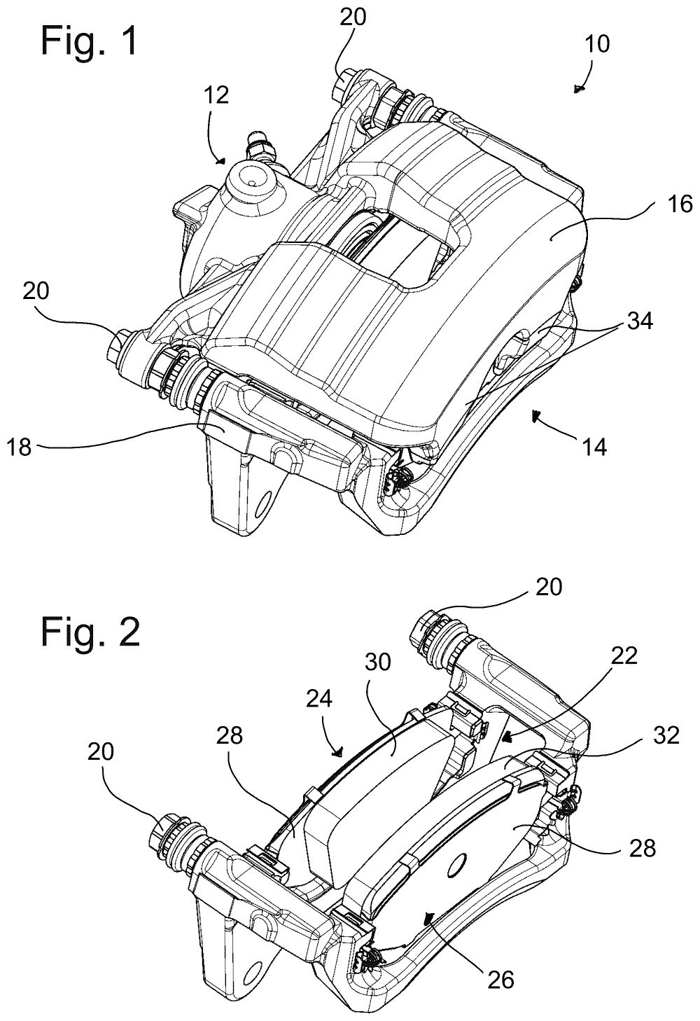

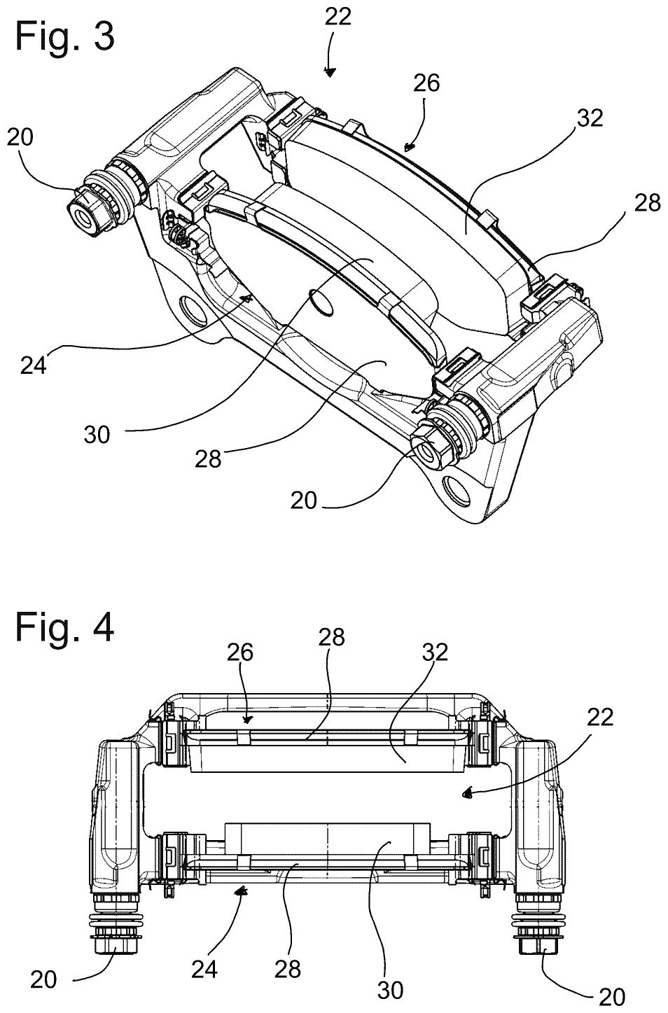

FIGS. 1 to 4 show a vehicle brake 10 having an exemplary arrangement of an electromechanical actuator unit 12.

Here, the vehicle brake 10 is a disc brake and is assigned to a wheel of the vehicle. In addition to the actuator unit 12, the vehicle brake furthermore comprises a brake housing 14 with a brake calliper 16 and a brake carrier 18, by which the vehicle brake 10 is secured on the body of the vehicle.

In this context, the brake calliper 16 is connected to the brake carrier 18 via linear guides 20 and is mounted movably and thus in a floating manner in the axial direction relative to the brake carrier 18 via the said guides.

The brake calliper 16 surrounds a brake rotor (not shown), for example a brake disc, which can be clamped in the axial direction by a brake pad set 22.

The brake pad set 22 comprises an inner brake pad 24 and an outer brake pad 26, wherein each brake pad 24, 26 has a backplate 28 and a brake lining 30, 32, which is mounted on the backplate 28 and comes into contact with the brake rotor when the vehicle brake 10 is actuated.

Here, the backplates 28 correspond to the normally used backplates 28, and therefore the brake pad set 22 can be installed in any vehicle brakes 10 without the need to exchange the vehicle brake 10.

In order to secure the brake linings 30, 32 on the backplates 28, the brake linings 30, 32 can each have one or more extensions on their side facing the backplate 28, wherein these extensions engage in recesses in the backplates 28.

Alternatively, the backplates 28 too can have extensions on their sides facing the brake linings 30, 32, which extensions engage in recesses in the brake linings 30, 32.

The brake pad 24 on the inside in the axial direction is mounted on the brake carrier 18 in such a way as to be movable in the axial direction. In contrast, the brake pad 26 on the outside in the axial direction rests against at least one abutment extension 34, which is an integral part of the brake calliper 16. Usually, the outer brake pad 26 rest against two laterally spaced abutment extensions 34, as shown in FIG. 1.

For lateral mounting and to provide axial mobility of the brake pads, the brake carrier 18 has a U-shaped receptacle for each brake pad and, on the two side walls of the U, a recess into which a laterally protruding finger provided on the backplate projects in each case.

When the vehicle brake 10 is activated, the brake pad 24, which is on the inside along a rotation axis of the actuator unit 12 which defines the axial direction, is actively subjected to an application force by the actuator unit 12, for example by a brake cylinder.

In one exemplary arrangement, the rotation axis of the actuator unit 12 also corresponds to the cylinder axis of the brake housing 14 and the brake rotor axis of rotation of the brake rotor.

The axially movable brake calliper 16 ensures that the brake pad 26 which is on the outside in the axial direction is likewise acted upon by the application force. In this case, the application force is distributed substantially uniformly in terms of magnitude between the inner brake pad 24 and the outer brake pad 26. Thus, as a result of the contact pressure force provided, frictional engagement with the brake rotor can be ensured for both brake pads 24, 26 of the brake pad set 22, said engagement being used to decelerate or hold the vehicle.

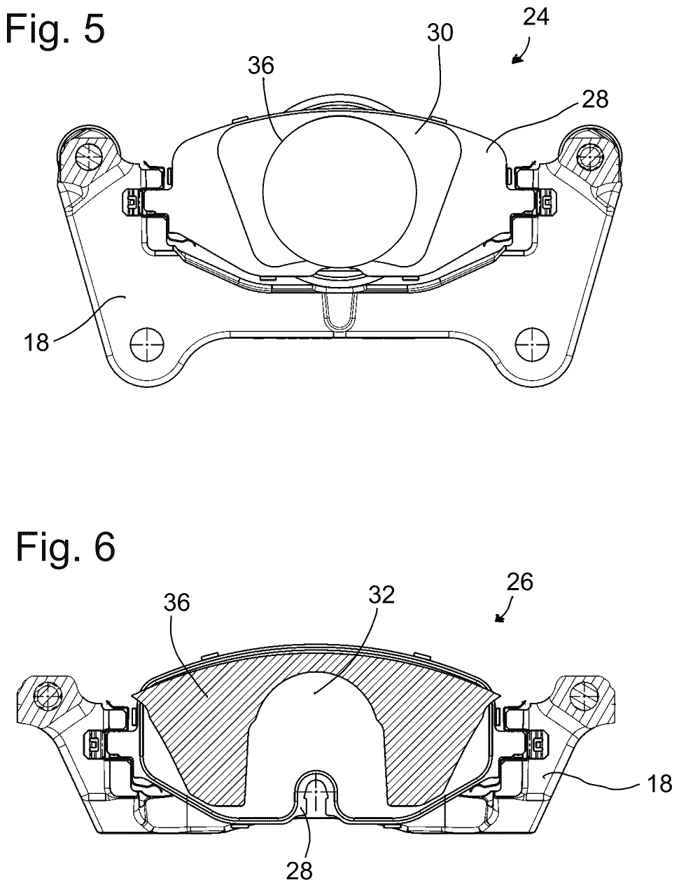

It can be seen in FIG. 5 that the actuator unit 12, and more specifically, the brake cylinder, engages centrally on the inner brake pad 24.

FIG. 1, on the other hand, shows the abutment extensions 34, on which the backplate 28 of the outer brake pad 26 is supported.

In comparison with FIGS. 5 and 6, it can be seen that, when viewed in the axial direction, the rear-side contact surface 36 of the inner brake pad 24 with the actuator unit 12 is situated between the rear-side contact surfaces 36 of the backplate 28 of the outer brake pad 26 with the abutment extensions 34.

To ensure uniform application of force across the respective brake linings 30, 32, the inner brake lining 30 and the outer brake lining 32 differ in size and/or also in geometrical shape in plan view.

That is to say, for example, that the inner brake pad 24 has a square or circular brake lining 30, while the outer brake pad 26 has an arc-shaped or rectangular brake lining 32.

Ideally, the size and/or the geometrical shape of the brake linings 30, 32 in plan view are/is chosen so that the rear-side contact surfaces 36 do not protrude beyond the respective brake lining 30, 32.

However, the brake linings 30, 32 should also not be significantly larger than the rear-side contact surface 36, thus making it possible to avoid non-uniform application of force to the respective brake linings 30, 32.

Accordingly, the area of the brake lining 30 of the inner brake pad 24 is smaller than the area of the brake lining 32 of the outer brake pad 26 in plan view since the rear-side contact surface 36 of the inner brake pad 24 is restricted to the actuator unit 12, for example, the brake cylinder. In contrast, as already mentioned above, the rear-side contact surface 36 of the outer brake pad 26 corresponds to the two abutment extensions 34.

Owing to the use of an inner brake lining 30 with a smaller area in plan view, therefore, potentially greater wear and thus a residual braking torque as well as troublesome noises resulting therefrom are avoided. In this case, the brake lining 30 of the inner brake pad 24 has a smaller area than the brake lining 32 of the outer brake pad 26, for example, an area which is smaller by at least 10%.

Ideally, the area of the inner brake lining 30 is between 20 and 300% smaller than the area of the outer brake lining 32. In other words, the area of the outer brake lining 32 is at least 10%, and in one exemplary arrangement, between 20 and 300% larger than the area of the inner brake lining 30. Thus, the difference between the inner brake lining 30 and the outer brake lining 32 is outside the production tolerance.

In order to continue to ensure uniform wear of the two brake linings 30, 32, the volume of wear of the inner brake pad 24 and the volume of wear of the outer brake pad 26 differ by less than 10%.

To ensure that the volume of wear of the inner brake lining 30 does not differ too much from that of the outer brake lining 32, the brake lining 30 of the inner brake pad 24 is thicker than the brake lining 32 of the outer brake pad 26. That is to say that the smaller the area of the brake lining 30, the greater is the thickness of the brake lining 30.

Since there is thus virtually no difference in the volumes of wear of the inner brake pad 24 and of the outer brake pad 26, the entire brake pad set 22 can be exchanged in each case without wasting material.

In addition, the backplate 28 of the inner brake pad 24 can be thicker than the backplate 28 of the outer brake pad 26. Alternatively, the thickness of the two backplates 28 of the brake pad set 22 is the same.

In principle, the brake lining 30, 32 can be pressed more strongly against the brake rotor if a thicker backplate 28 is used. A thicker backplate 28 thus makes it possible to apply a more uniform braking force. Since the inner brake lining 30 has a smaller area than the outer brake lining 32, it may thus be advantageous if the backplate 28 of the inner brake pad 24 is somewhat thicker.

In order to adapt better to the rear-side contact surface 36 of the abutment extensions 34 on the outer brake pad 26, the brake lining 32 of the outer brake pad 26 can be divided into two. In this case, the gap between the split brake lining 32 is situated at the level of the interspace between the two abutment extensions 34 (see FIG. 6).

The two brake linings 30, 32 may differ not only in their size and geometrical shape in plan view but also in their material. That is to say that the inner brake lining 30 can be manufactured from a different material to the outer brake lining 32. Here, the difference between the materials lies in the friction coefficient.

Thus, for example, a material with a higher friction coefficient and higher propensity to wear can be selected for the outer brake lining 32 in order to meet the corresponding demands on the brake lining 32.

Since the size and shape of the brake linings 30, 32 differ, the brake linings 30, 32 are also situated at different radial heights in relation to the brake rotor.

As an alternative to the square or circular shape in the plan view of the inner brake lining 30, a rectangular shape or arc shape approximating to the shape of a square may also be used. In this case, the rectangular shape of the inner brake lining 30 has a ratio of width b to height h of less than or equal to 3:2, and in one exemplary arrangement, less than or equal to 4:3, and in one exemplary arrangement, less than or equal to 5:4. If the inner brake lining 30 has an arc shape, the width at the radial height of the inner brake lining 30 at which the central axis A of the brake cylinder is located (see FIG. 5) is taken as the width, the said axis also forming the central axis of the driven spindle in the case of an electromechanical brake.

As an alternative, it may be the case here, for example, that, for the brake lining 30 of the inner brake pad 24, the ratio of the height h to the width b of the inner brake lining 30 is between 0.6 and 1.1.

From this, it follows therefore that the height of the inner brake lining 30 should at least be not significantly less than the width of the inner brake lining 30, and therefore the inner brake lining 30 has a somewhat square or rectangular shape in a view towards the friction surface.

1. A brake pad set for disc brakes, comprising: an inner brake pad and an outer brake pad, wherein each brake pad has a backplate and a brake lining, which is mounted on the backplate and comes into contact with a brake rotor during operation, wherein the inner brake lining and the outer brake lining differ in size in plan view, wherein a volume of wear of the inner brake pad and a volume of wear of the outer brake pad differ by less than 10%.

2. The brake pad set according to claim 1, wherein the brake lining of the inner brake pad is of square or circular design in plan view, and/or the brake lining of the outer brake pad has an arc shape or a rectangular shape.

3. The brake pad set according to claim 1, wherein the brake lining of the outer brake pad has a larger area in plan view than the brake lining of the inner brake pad.

4. The brake pad set according to claim 3, wherein the brake lining of the inner brake pad is thicker than the brake lining of the outer brake pad.

5. The brake pad set according to claim 1, wherein the backplate of the inner brake pad is thicker than the backplate of the outer brake pad or is the same thickness.

6. The brake pad set according to claim 1, wherein the brake lining of the outer brake pad is divided into two.

7. The brake pad set according to claim 1, wherein the brake lining of the outer brake pad and the brake lining of the inner brake pad are manufactured from different materials.

8. The brake pad set according to claim 1, wherein the ratio of the height to the width of the brake lining of the inner brake pad is between 0.6 and 1.1.

9. The brake pad set according to claim 1, wherein the brake lining of the inner brake pad and the brake lining of the outer brake pad are arranged at different radial heights in relation to the brake rotor.

10. A vehicle brake, comprising a brake calliper, a brake carrier, into which a brake rotor projects, an actuator unit and a brake pad set according to claim 1.

11. The Vehicle brake according to claim 11, wherein the actuator unit engages centrally on the inner brake pad, and in that the brake calliper has abutment extensions, on which the backplate of the outer brake pad is supported by rear-side contact surfaces when the brake is activated, wherein the inner brake pad has a rear-side contact surface with the actuator unit, which surface, when viewed in the axial direction, is situated between the contact surfaces of the outer backplate with the abutment extensions.

12. The brake pad set according to claim 1, wherein the inner brake lining and the outer brake lining also differ in geometrical shape in plan view.

13. The brake pad set according to claim 3, wherein the brake lining of the outer brake pad has a larger area in plan view by at least 10%.

14. The brake pad set according to claim 3, wherein the brake lining of the outer brake pad has a larger area in plan view by between 20% and 300%.

15. The brake pad set according to claim 2, wherein the backplate of the inner brake pad is thicker than the backplate of the outer brake pad or is the same thickness.

16. The brake pad set according to claim 15, wherein the brake lining of the outer brake pad and the brake lining of the inner brake pad are manufactured from different materials.

17. The brake pad asset according to claim 15, wherein the ratio of the height to the width of the brake lining of the inner brake pad is between 0.6 and 1.1.

18. The brake pad set according to claim 15, wherein the brake lining of the inner brake pad and the brake lining of the outer brake pad are arranged at different radial heights in relation to the brake rotor.
